(19) United States
(12) Patent Application Publication
(10) Pub. No.: US 2015/0120360 A1
(43) Pub. Date: Apr. 30, 2015

(54) OVERHEAD-MOUNTED INFRARED SENSOR ARRAY BASED HOTELING SYSTEMS AND RELATED METHODS

(71) Applicant: Redwood Systems, Inc., Fremont, CA (US)

(72) Inventors: Luc W. Adriaenssens, Plano, TX (US); Stewart Findlater, Los Gatos, CA (US); Robert B. Henig, Redwood City, CA (US)

(21) Appl. No.: 14/521,498

(22) Filed: Oct. 23, 2014

Related U.S. Application Data
(60) Provisional application No. 61/895,036, filed on Oct. 24, 2013.

(51) Int. Cl. G06Q 10/06; G01V 8/10

(52) U.S. Cl. CPC G06Q 10/063116; G01V 8/10
USPC 705/7.16; 250/349

(57) ABSTRACT

Hoteling systems for open work areas are provided that may be used track occupancy of work spaces within the work area. These systems include a plurality of infrared sensor arrays that are mounted above the work area. Each infrared sensor array includes a two-dimensional array of infrared emission sensors. The field of view patterns of at least some of the infrared emission sensors project into the work spaces. These systems further include a controller that is remote from at least some of the infrared sensor arrays. The controller is configured to determine an occupancy state of each of the work spaces based at least in part on information received from the infrared sensor arrays.

### CROSS-REFERENCE TO RELATED APPLICATION

The present application claim priority under 35 U.S.C. §119 to U.S. Provisional Application Ser. No. 61/895,036, filed Oct. 24, 2013, the entire content of which is incorporated herein by reference as if set forth in its entirety.

### FIELD OF THE INVENTION

The present invention is directed to hoteling systems and, more particularly, to sensor based hoteling systems.

### BACKGROUND

Traditionally, most corporations, businesses, government agencies and other entities that employ office workers have provided many if not most of their employees with designated work spaces in the office that are permanently assigned to the respective employees. Employees were expected to report to work each day, and to perform their work from the office with obvious exceptions where off-site work was required. However, in recent years, many employers have allowed at least selected employees to telecommute, as improved telecommunications capabilities have made such working arrangements more feasible. Additionally, many employers now offer much greater flexibility with respect to the core hours that employees are expected to be in the office in order to allow employees to avoid rush hour traffic or to accommodate child care or other needs. Thus, it is typical today for some employees to arrive at work very early in the morning and then leave early, while other employees may come in much later and leave late in the evening. Moreover, certain types of employees such as sales people, customer representatives, consultants and others may spend much of their time out of the office calling on customers or potential customers. Furthermore, some employees may require different office space needs at different times and/or on different days (e.g., they may need an office one day, a conference room another day and a cubicle may be acceptable on other days). Travel, vacation and sick time also reduce how often employees are physically present in the office. These trends result in a far more dynamic office environment with employees being present at different times and on different days, such that much of the work force may not necessarily be present in the office at any given time. In addition, the digital age has reduced the need for physical storage of items like large paper files.

Another trend in recent years is that office space has become increasingly expensive as real estate valuations have escalated in many major metropolitan areas. In fact, for many companies, real estate is now the company's second largest expense behind employee costs (e.g., salary and benefits). Because of the above-described trends, many employers are moving to “hoteling” or “hot desking” schemes in an effort to decrease their overhead in an increasingly competitive, globalized marketplace. Under a “hoteling” or “hot desking” scheme, employees may not have an assigned office, cubicle, desk, workstation or the like (which are collectively referred to herein as “work spaces”). Instead, a pool of offices, cubicles and other work spaces are shared by a larger number of employees. With a “hot desking” concept, work spaces are not assigned or reserved, but instead are simply claimed by employees as they arrive at work on a first-come-first-served basis. In contrast, “hoteling” refers to a reservation-based method of supporting unassigned work spaces in an office environment. With hoteling, an employee may reserve a work space in advance or may be assigned a work space upon arriving at work. Physical storage can be provided in centralized areas (e.g. filing cabinet rooms) as required. Both hot desking and hoteling enable support of more employees in less space, which may significantly reduce an employer's real estate costs.

A variety of different types of hoteling systems have been proposed, which may vary significantly in terms of complexity. Typically, the corporation or other entity that employs a hoteling scheme uses a software application to keep track of the available work spaces and to assign these work spaces to employees as needed. Employees access the software application, either when they arrive at work or in advance, log in, and then either request or actively reserve a work space. The employee may be allowed to select a particular work space (or type of work space), or may simply be assigned a work space based on their request and current availability. Employees may also be required to check-out of work spaces when they are finished for the day so that the work spaces may be cleaned/prepared for the next occupant and/or so that the software reservation system will know that the work space is now available for use by a different employee.

### SUMMARY

Pursuant to embodiments of the present invention, hoteling systems for open work areas that have a plurality of work spaces are provided that may be used to track occupancy of the work spaces. These systems include a plurality of infrared sensor arrays that are mounted above the open work area. Each infrared sensor array includes an array of infrared emission sensors. The field of view patterns of at least some of the infrared emission sensors project into the work spaces. These systems further include a controller that is remote from at least some of the infrared sensor arrays. The controller is in communications with the infrared sensor arrays, and is configured to determine an occupancy state of each of the work spaces based at least in part on information received from the infrared sensor arrays.

In some embodiments, each occupancy state determination may be based on information received from at least two of the infrared emission sensors. The two infrared emission sensors used to determine each occupancy state for a work area may be from different infrared sensor arrays. The occupancy state determination for a first work space may be based on comparing information received from infrared emission sensors that have field of view patterns that project onto the first work space to stored criteria. The stored criteria may be based on data that was recorded during a commissioning process for the work area.

In some embodiments, the field of view patterns of at least two of the infrared emission sensors from the same infrared sensor array may project into the same work space. In other embodiments, the field of view patterns of a first infrared emission sensor of a first of the infrared sensor arrays and of a second infrared emission sensor of a second of the infrared sensor arrays may project into the same work space. The infrared sensor arrays may be powered via cables that include at least first and second conductors, and the information received from the infrared sensor arrays may be transmitted to the controller over at least one of these conductors. The cables may also provide power signals to light fixtures in the work area and/or may serve as a transmission medium for transmitting control signals that are used to control the light fixture. In some embodiments, at least two of the infrared sensor arrays may be powered by a common cable.

In some embodiments, each occupancy state determination may be based at least in part on the detection by one of the infrared sensor arrays of a change in temperature that exceeds a predetermined magnitude and that occurs within a predetermined time. In some embodiments, at least one of the infrared emission sensors in a first infrared sensor array may have a field of view pattern that partially overlaps with the field of view pattern of at least one other of the infrared emission sensors in the first infrared sensor array. Similarly, at least one of the infrared emission sensors in the first infrared sensor array may have a field of view pattern that partially overlaps with the field of view pattern of an infrared emission sensor in a second infrared sensor array. The infrared sensor arrays may be mounted in or from a ceiling of the work area, and at least half of the infrared emission sensors in each infrared sensor array may project into the work spaces at an angle of at least twenty degrees from axes that pass through the infrared emission sensors that are normal to a plane defined by the ceiling.

Pursuant to further embodiments of the present invention, methods of assigning work spaces in a hoteling system are provided in which infrared emissions are detected within individual work spaces in an open work area using a plurality of overhead mounted infrared sensor arrays, where the infrared sensor arrays each include a plurality of sensors and the infrared sensor arrays are arranged so that field of view patterns of multiple sensors extend into each work space. Data is transmitted from the infrared sensor arrays to a controller. The controller determines an occupancy state of each of the work spaces based at least in part on the data received from the infrared sensor arrays. A work space that has been determined to be currently unoccupied is then assigned to an individual.

In some embodiments, a graphical display may be generated and automatically updated that illustrates the determined occupancy state of the work spaces. In some embodiments, the infrared emissions detected by each sensor in the infrared sensor arrays that is associated with an individual moving in each of the work spaces may be measured, and these measured infrared emissions may be used in making the occupancy state determinations.

In some embodiments, the infrared sensor arrays may be Grid Pattern Infrared sensor arrays that detect infrared emissions and convert the detected infrared emissions to temperature values. A first of the infrared sensor arrays may be powered via a cable that includes at least first and second conductors, and the data may be transmitted from the first infrared sensor array to the controller over at least one of the first and second conductors. The first and second conductors of the cable may provide a power signal to a light fixture, and at least one of the first and second conductors may be configured to provide a transmission medium for transmitting control signals that are used to control the light fixture.

In some embodiments, each occupancy state determination may be based on information received from at least two of the infrared emission sensors. The occupancy state determination may be based at least in part on the detection of a change in temperature that exceeds a predetermined magnitude and that occurs within a predetermined time. The field of view patterns of infrared emission sensors from at least two infrared sensor arrays may project into each work space.

### BRIEF DESCRIPTION OF THE DRAWINGS

FIG. 1 is a schematic diagram illustrating the operation of a hoteling system that uses motion sensors mounted under the desk of each work space in a work area.

FIG. 2 is a schematic overhead diagram illustrating shortcomings of using conventional infrared motion sensors to implement a hoteling system.

FIG. 3 is a schematic overhead diagram illustrating the operation of a hoteling system according to certain embodiments of the present invention.

FIG. 4 is a schematic overhead diagram of the hoteling system of FIG. 3 illustrating how multiple infrared sensor arrays may be used to determine the occupancy state of a plurality of work spaces within the work area.

FIG. 5 is a schematic diagram illustrating how the field of view patterns of the infrared emission sensors used in embodiments of the present invention may project into the work spaces at angles from a vertical axis.

FIG. 6 is a schematic side view of a portion of a work area that illustrates how the field of view patterns of some sensors may be blocked by desks, cubicle walls or other stationary objects, or by individuals standing in or walking through the work area.

FIG. 7 is a schematic diagram illustrating how the infrared sensor arrays used in embodiments of the present invention may be integrated with a solid state lighting system.

FIG. 8 is a schematic diagram illustrating a graphical display of a hoteling system that may be used to show work space occupancy state information.

### DETAILED DESCRIPTION

One of the problems that corporations or other entities face when considering whether hoteling is economically attractive is a lack of data that may aid decision making. Specifically, many employers lack hard data on the percent occupancy of their work areas on a daily or hourly basis. This makes is difficult to estimate how many work spaces they would need to ensure that they have an adequate number of work spaces available during the busiest times, and the space and equipment savings that implementation of a hoteling scheme may provide. Another problem with hoteling is that some employees may reserve work spaces “just in case” they are needed, but then not show up and use these work spaces. A need therefore exists for estimating occupancy of work areas including both closed offices and open work areas, and an associated need exists for methods of efficiently implementing hoteling systems in office environments where such systems are justified by cost or other considerations.

One method of determining whether or not a work space is occupied is to sense whether or not there is any motion in the work space. A wide variety of motion detectors are commercially available that may used to accomplish this task. Conventional motion detectors typically employ infrared sensors. All materials with a temperature above absolute zero (i.e., a temperature above −273° C.) radiate infrared energy. The level of radiation is a function of the temperature of the object as well as the emissivity of its outer surface. People generally have an infrared emission profile or “signature” that differs substantially from the infrared signatures of other objects such as desks, walls, floors, furniture, etc. that are present in an office environment.

Infrared sensors may include a lensing system (e.g., a low cost Fresnel lens) that focuses infrared energy from a specific field of view (i.e., a cone) onto a chip where the energy is absorbed. In motion detection applications, a pair of infrared sensors are typically positioned adjacent to each other and arranged to have partially overlapping field of view cones. The infrared sensors are configured in a differential manner (i.e., opposite polarity) in a circuit so that the sum of the outputs of the two infrared sensors would be approximately zero if the two infrared sensors illuminated the exact same field of view. As noted above, the field of view cones of the two infrared sensors are generally offset slightly, so that the two infrared sensors do not see the exact same image and associated infrared signature. When an individual moves within the field of view of the motion detector, the movement will cause a change in the amount of infrared energy received by each of the sensors. Moreover, as the field of view patterns of the two sensors are slightly offset from each other, the change in the received infrared energy at each sensor will be different, and hence the movement will result in a sudden change in the differential signal between the two infrared sensors. Thus, a sudden, relatively large gradient in the differential sensor signal is indicative of a motion event.

Multiple, differentially combined sensors are used in motion detection applications in order to reduce the possibility of “false positives” that might otherwise occur due to other changes in infrared emissions. For example, if external light is present within the field of view, it can change the infrared emissions of the objects illuminated by the light. However, such external light will typically cause a similar amount of increase in the infrared emissions detected by both sensors, and hence the difference in the respective outputs of the two sensors that results from this external light may be very small. Similar effects may be expected with other stationary infrared emission sources such as heat vents, computer exhaust fans and the like.

In some motion detectors, the level of change needed to trigger a motion event is a variable that can be adjusted. This enables fine tuning to balance potential problems caused by triggering too often or not often enough for specific applications. For instance, if motion detectors are mounted in the ceiling and the trigger level is too low, HVAC on/off cycling may trigger a motion event (particularly if the output vent is only in the field of view cone of one of the sensors), resulting in a “false-positive” reading. Similarly, if the ceiling height is rather high and the trigger level is too high, people working at their desk with little movement may not trigger a motion event for a specific time-out duration resulting in “false negative” readings.

In recent years, a variety of new infrared sensor products have been brought to market that include an array of sensors. Two examples include Panasonic's 8×8 Grid-Eye sensor array (part # AMG8831) and Melexis' 16×4 sensor array (part # MLX90620). Both of these products include a grid of infrared sensors, where each sensor has a much narrower field of view cone than a conventional pair of infrared sensors in a motion detector. For instance, the field of view cone for each sensor in the Panasonic product is about 8 degrees. The field of view cone for each sensor in the Melexis product is between 2.6 degrees and 4.1 degrees dependent on the type of lens used. These infrared sensor arrays are generally referred to as Grid Pattern Infrared (“GPIR”) sensor arrays. A wide variety of grid array sizes and field of view cones for the sensors in the array are possible.

Conventional motion detectors can be placed in offices with closed walls and may be effective in assessing occupancy for the office in which they are installed. Such motion detectors are currently used in closed offices to control overhead lights based on assessments regarding office occupancy in order to reduce energy costs. Office occupancy data gathered using such motion detectors may be transmitted wirelessly, or via dedicated or shared cabling, to a central controller that can process the data and/or store it for future use, such as historic statistics analysis. Existing solutions on the market, such as Building Performance Lighting Solutions from Redwood Systems, provide the underlying infrastructure that may enable such solutions.

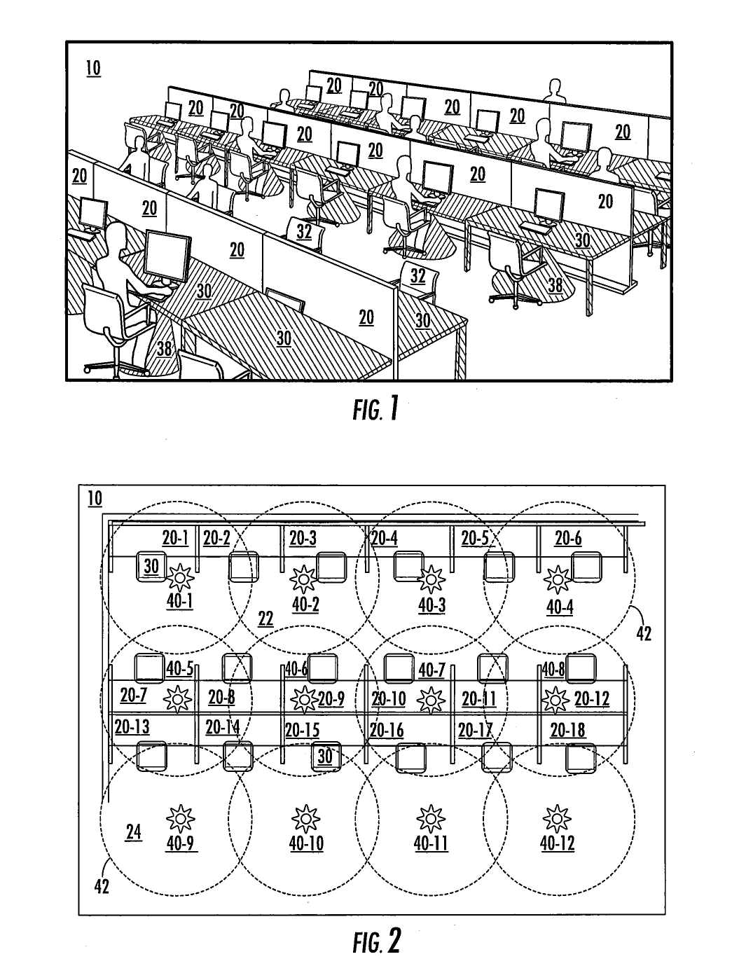

Various difficulties may arise, however, if conventional motion detectors are used to assess workstation occupancy in “open” work areas (i.e., work areas that do not have floor to ceiling walls) such as work areas in which cubicles, desks and/or modular office space are installed in a large open area. FIG. 1 is a schematic perspective view of a work area 10 in which a plurality of work spaces 20 in the form of cubicles are arranged in tightly packed rows. Each cubicle includes a desk 30 and a chair 32. As shown in FIG. 1, one possible way of using conventional motion detectors to assess cubicle occupancy in the work area 10 is to mount a dedicated motion detector 38 within each cubicle 20. Such a solution is available from OccupEye (www.Occupeye.com). The OccupEye solution places a battery powered motion detector 38 on the underside of each desk 30. In FIG. 1, each motion detector 38 is represented by its field of view cone. When an individual is seated in the chair 32, the battery powered motion detector 38 detects periodic movements by the individual and wirelessly communicates this information to a centralized controller (not shown in FIG. 1). The centralized controller uses algorithms to process this information and make determinations as to whether or not each cubicle 20 is presently occupied. However, this solution may require a large number of motion detectors 38, along with ongoing maintenance in terms of battery replacement. An alternate solution might be to use motion detectors 38 that are powered through the building's electrical system and/or to connect each motion detector 38 to the centralized controller via communications cabling. However, if the cubicles 20 are rearranged, significant work may be required to rearrange the electrical wires and/or communications cabling. As such, including a motion detector 38 in each cubicle 20 may be unduly expensive and impractical.

Another possible way of using motion detectors to record occupancy data in an open work area is to mount motion detectors overhead in the light fixtures or ceiling. FIG. 2 is a schematic overhead (plan) view of a portion of the work area 10 of FIG. 1 that illustrates how such overhead motion detectors may be used. As shown in FIG. 2, the work area 10 includes a plurality of cubicles 20 (which are labeled 20-1 through 20-18 in order to differentiate between the different cubicles) that are arranged in rows separated by walkways 22 and 24. A plurality of ceiling-mounted motion detectors 40 are provided in the work area 10. As can be seen, a relatively dense deployment of motion detectors 40 is provided in this example, with a motion detector 40 mounted in each light fixture so that twelve motion detectors 40-1 through 40-12 are provided for eighteen cubicles 20. The dashed lines 42 in FIG. 2 represent the field of view cone for each motion detector 40 as projected onto the floor of the work area 10. Thus, for example, if an employee is occupying cubicle 20-2, the employee may be detected by both motion detectors 40-1 and 40-2, as the field of view cones 42 for each of these motion detectors 40-1 and 40-2 extend into cubicle 20-2.

Unfortunately, however, the motion detectors 40 in the example of FIG. 2 may not be capable of assessing the exact location of the employees that are present in the work area 10. For example, motion detector 40-1 can only conclude that one or more individuals are present in either or both cubicles 20-1 and 20-2 or in the walkway 22; it cannot determine with a reasonable degree of certainty that an individual is within a specific cubicle 20. Similarly, motion detector 40-2 can only conclude that one or more individuals are present in cubicles 20-2 and 20-3 or walkway 22. Even if two motion detectors are processed together, they still may not be capable of drawing definitive conclusions as the occupancy of these cubicles. Therefore, no definitive conclusions can be drawn as to the occupancy of cubicles 20-1 through 20-3. Similar problems apply to the other cubicles 20.

One way to overcome the shortcomings of the cubicle occupancy detection system proposed in the example of FIG. 2 is to dedicate a motion detector 40 for each cubicle 20, where the motion detector 40 is located directly above the cubicle 20. The sensitivity of each motion detector 40 can be selected to trigger a presence detection when an individual is present directly under the motion detector 40 where the sensitivity of the motion detector 40 is greatest. Although this solution would work, it also has various shortcomings. One disadvantage is that a very high density of motion detectors 40 would be needed to implement such a solution (i.e., one motion detector 40 per cubicle 20) which increases cost due to the direct cost of the motion detectors 40 and the indirect costs of installing the motion detector 40 and purchasing and installing the associated cabling. A second disadvantage is that in practice the actual layout of the cubicles 20 in a work area 10 may not exactly match the design map. If the motion detectors 40 are sufficiently misaligned with the positions of the chairs 32, false conclusions on cubicle occupancy may be drawn. A third disadvantage is that if the cubicles 20 are rearranged, which may occur every few years in many cases, the motion detectors 40 would also have to be rearranged, which may involve significant extra cost and disruption.

Pursuant to embodiments of the present invention, improved hoteling systems and methods are provided in which overhead-mounted infrared sensor arrays are used to track the occupancy state of a plurality of work spaces in a work area. Herein, a “sensor array” refers to a two-dimensional array of sensors that includes at least four sensors. The systems and methods according to embodiments of the present invention may be particularly useful for work areas that use cubicles, modular furniture, or open desk arrangements that may be reconfigured over time as work space needs evolve. In some embodiments, an infrared sensor array may be mounted in or adjacent to some or all of the light fixtures in the ceiling. Each infrared sensor array may include a plurality of narrow field of view infrared emission sensors arranged in a two dimensional pattern such as, for example, a rectangular grid, a circle, etc. Each infrared emission sensor in an array may record infrared emission readings. In some embodiments, these infrared emission readings may be converted to temperature readings. Typically, each sensor will continuously detect the total infrared emission within the field of view of the sensor. This infrared emission value may be represented as a voltage or current value that is output by the sensor. The field of view patterns of the sensors in the array will typically point in different directions so that the infrared sensor array may monitor the infrared emissions over a relatively wide area. The field of view patterns of the individual sensors within the array may partially overlap, although this may not always be the case. The field of view pattern for each sensor may be relatively narrow, such that the fields of view of multiple sensors from a single array may project into each work space. For example, in some embodiments, the field of view patterns for each sensor may be less than ten degrees. In other embodiments, the field of view pattern of each sensor may be less than five degrees. Moreover, many work spaces may have sensors from two different arrays that have field of views that project into the work space.

Typically a single, centralized controller will be provided for a work area and this controller will process data that it receives from the plurality of infrared sensor arrays. In some embodiments, raw infrared emission readings or raw temperature data that is based on the infrared emission readings may be collected at each infrared sensor array and transmitted to the centralized controller. In other embodiments, each infrared sensor array may include circuitry that detects sudden changes in the infrared emission readings recorded on one or more of the sensors in the array (or sudden changes in the difference in the readings between two sensors with partially overlapping field of view patterns). In such embodiments, only data relating to these sudden changes in the infrared emission readings of some of the sensors in the array may be communicated to the controller, which data can be used to infer occupancy of a cubicle or other work space. In still other embodiments, further digital processing may be performed locally at the infrared sensor arrays so that work space occupancy information may instead be transmitted from the infrared sensor arrays to the centralized controller.

FIG. 3 is a schematic overhead view of a hoteling system 100 according to embodiments of the present invention that may be used to track work space occupancy in a work area 110. As shown in FIG. 3, as in FIG. 2, the work area 110 includes eighteen cubicles 120-1 through 120-18, which are arranged in three rows of six cubicles each. Walkways 122, 124 are provided between the rows. A first infrared sensor array 140 is mounted overhead, on or near a ceiling mounted light fixture 150. As shown in the call-out in FIG. 3, the infrared sensor array 140 in the depicted embodiment is a 4×4 grid pattern infrared sensor array that includes sixteen infrared emission sensors 142. It will be appreciated that the 4×4 grid pattern infrared sensor array 140 that is used in the embodiment of FIG. 3 is for illustrative purposes only. Different two-dimensional grid arrangements including rectangular, circular or other arrangements may be deployed, and any appropriate number of infrared emission sensors may be included in the infrared sensor array 140. It will also be appreciated that the spacing between adjacent field of view patterns does not have to be uniform.

As is also shown in FIG. 3, each infrared emission sensor 142 has an associated field of view pattern 144 that projects onto the floor of the work area 110 (assuming that the field of view pattern is not blocked at some point by a wall, desk or other object). In FIG. 3, each circle 144 represents the field of view pattern as projected on the floor of the work area 110 for a respective sensor 142 in the infrared sensor array 140, and the dots 146 show the center of the respective field of view patterns 144. In the depicted embodiment, the field of view patterns 144 for the sixteen infrared emission sensors 142 form a square grid pattern. Additionally, the field of view patterns 144 of adjacent infrared emission sensors 142 overlap. The degree of overlap may be varied from substantial overlap to no overlap whatsoever.

As shown in FIG. 3, the single infrared sensor array 140 may collect infrared emissions from two cubicles (namely all of cubicle 120-1 and much of cubicle 120-2) and most of the walkway 122 that runs between cubicles 120-1 through 120-2 and cubicles 120-7 through 120-8.

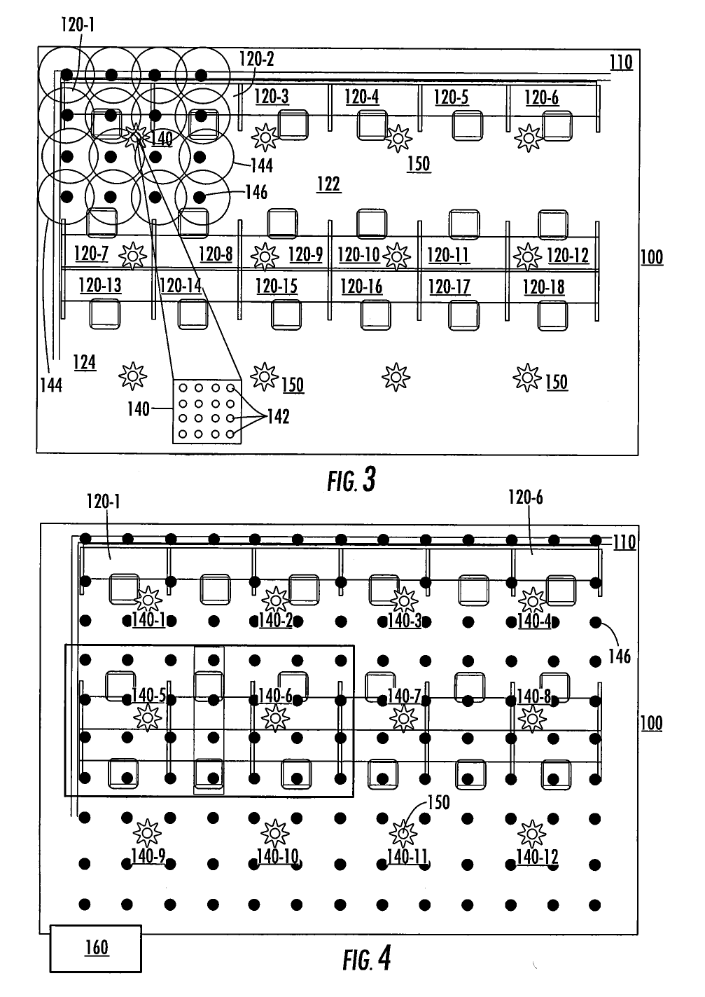

FIG. 4 is an identical view of the work area 110 shown in FIG. 3, with the only difference being that in FIG. 4 an infrared sensor array 140 is provided at or near each of the light fixtures 150 in the ceiling. As is readily apparent, the twelve infrared sensor arrays 140-1 through 140-12 provided in the embodiment of FIG. 4 may provide dense coverage of the work area 110.

In the embodiment of FIG. 4, the field of view patterns 144 of the infrared emission sensors 142 on adjacent infrared sensor arrays 140 are also designed to overlap, when projected onto the floor of the work area 110 without interference from objects. In particular, the sixteen infrared emission sensors 142 of each infrared sensor array 140 form a four-by-four grid. The field of view patterns 144 for the four infrared emission sensors 142 on the left side of the grid formed by a first infrared sensor array (e.g., array 140-6) are designed to substantially overlap with the field of view patterns 144 for the four infrared emission sensors 142 on the right side of the infrared sensor array 140-5 that is to the left of infrared sensor array 140-6. A pair of rectangular boxes have been added to FIG. 4 to show the coverage area of infrared sensor arrays 140-5 and 140-6 in order to better illustrate the region where overlapping coverage will occur. Likewise, the field of view patterns 144 for the four infrared emission sensors 142 on the right side of the grid formed by infrared sensor array 140-6 are designed to substantially overlap with the field of view patterns 144 for the four infrared emission sensors 142 on the left side of the infrared sensor array 140-7 that is to the right of infrared sensor array 140-6. The field of view patterns 144 for the four infrared emission sensors 142 on the top of the grid formed by infrared sensor array 140-6 are similarly designed to substantially overlap with the field of view patterns 144 for the four infrared emission sensors 142 on the bottom of the infrared sensor array 140-2, and the field of view patterns 144 for the four infrared emission sensors 142 on the bottom of the grid formed by infrared sensor array 140-6 are designed to substantially overlap with the field of view patterns 144 for the four infrared emission sensors 142 on the top of the infrared sensor array 140-10. Providing such overlap may be desired for improved robustness. While in the example of FIG. 4 the field of view patterns 144 of the infrared emission sensors 142 on the end rows and columns of each grid completely overlap with the field of view patterns 144 of the infrared emission sensors 142 on the end rows and columns of adjacent infrared sensor arrays infrared emission 140, it will be appreciated that in other embodiments there may only be partial overlap and in still other embodiments there may be no overlap. In addition, various tolerances in the infrared sensor array manufacturing process and in the positioning and orienting of the light fixtures and/or sensor arrays may result in slight differences between design objectives and actual “as built” results.

Each infrared emission sensor 142 may be configured to read and output a voltage or current that represents an infrared emission level of the objects within the field of view pattern 144 of the infrared emission sensor 142. The infrared sensor array 140 is typically configured to convert the detected infrared emission level into a temperature reading that represents a weighted average temperature reading across the field of view pattern 144 of the infrared emission sensor 142 at issue. Thus, if there are no intervening objects, a particular infrared emission sensor 142 will output a temperature measurement for the floor of the work area 110 that is within its field of view pattern 144. If intervening objects are present (e.g., cubicle walls, filing cabinets, desks, computers, people, etc.), the output of the infrared emission sensor 142 will provide a temperature reading of the intervening object (or a weighted average temperature if multiple different objects are within the field of view pattern 144).

The infrared sensor arrays 140 may be used to track occupancy of the work spaces 120 within work area 110. As noted above, each infrared sensor array 140 will transmit data such as, for example, temperature data or data regarding sudden changes in temperature (or infrared emission levels) or the level in change in temperature or infrared emissions to the centralized controller 160. This data may be used by a centralized controller 160 to infer the occupancy state of each work space 120 in the work area 110.

The centralized controller 160 may, for example, execute a software application that is used to make the occupancy determinations. As shown in FIG. 4, a large number of infrared emission sensors 142 may have field of view patterns 144 that project into a given work space 120 (e.g., 6-9 infrared emission sensors 142 per work space 120). Thus, when an individual is present in a particular work space 120, it is expected that increased infrared emission/temperature readings will be detected on multiple sensors 142 as the individual enters and moves around the work space 120. This is particularly true when the field of view patterns 144 for adjacent infrared emission sensors 142 are designed to partially overlap, which is the case in the example of FIGS. 3-4, as shown by the field of view patterns 144 that are illustrated in FIG. 3. Moreover, it will be appreciated that an individual that is in a work space 120 may not be moving at all times and/or may not be within the field of view pattern 144 of some of the infrared emission sensors 142 that project into the work space 120 at all times. Accordingly, determinations of occupancy may have a time component where the time between detected emission/temperature changes for various sensors 142 may be taken into account when making the occupancy determinations.

The centralized controller 160 may run appropriate algorithms to make determinations as to whether or not a particular work space 120 is occupied at any given time. These algorithms may consider, among other things, the data provided by each infrared emission sensor 142 that has a field of view pattern 144 that projects into the work space 120 at issue, the magnitude of the detected changes, the frequency of the detected changes, etc. Based on these parameters, the centralized controller 160 may continually make occupancy determinations for each work space 120 in the work area 110.

In some embodiments, a commissioning process may be performed that may be used to increase the accuracy of the algorithms used to make the occupancy determinations. As part of this commissioning or “training” process, a commissioning agent enters the first work space 120-1, instructs the system 100 that commissioning of work space 120-1 is starting (e.g., using a tablet computer that is in wireless communication with the centralized controller 160), and then moves around within the work space 120-1 perimeter to ensure that all sensors 142 having a field of view pattern 144 that projects into the work space 120-1 are triggered, while being careful not to move outside of the work space 120-1 (e.g., into the common walkway 122). In this fashion, infrared emission readings (or temperature readings) for each infrared emission sensor 142 that are indicative of an individual being present in work space 120-1 are identified. The commissioning agent then instructs the system 100 that commissioning of work space 120-1 has been completed. The commissioning agent then physically moves into work space 120-2 and repeats the process to perform commissioning with respect to work space 120-2.

The centralized controller 160 then performs processing to convert the infrared emission and/or temperature data that is received from the infrared sensor arrays 140 that have infrared emission sensors 142 with field of view patterns 144 within the various work spaces 120 to set trigger levels for determinations that each work space 120 is deemed occupied or unoccupied. As noted above, the trigger levels may be based on one or more of a variety of factors including, for example, infrared emissions/temperature data (or data regarding sudden changes therein) for each relevant sensor 142 and the readings on the relevant sensors 142 as a function of time.

Rapid large changes in the infrared emission levels on a particular sensor 142 (or corresponding temperature readings) may indicate extremely high confidence that an individual is present within a work space 120, as such changes will occur when an individual (body temperature of approximately 37° C.) moves into a sensor field of view pattern 144 that was previously filled with a floor, wall or other object having an approximate temperature of the ambient temperature of the work area, such as 25° C. Less rapid and smaller changes in infrared emission levels may indicate moderate confidence of presence of an individual in a work space 120, particularly where such changes are recorded on multiple infrared emission sensors 142. Very small and slow changes in infrared emission levels are likely background noise. One very simple default algorithm may assume that if the infrared emissions recorded by an infrared emission sensor 142 indicates a large or moderate level of movement, a conclusion will be made that the work space into which the infrared emission sensor 142 projects is occupied, while small changes in the infrared emissions recorded by a sensor 142 do not indicate presence. The actual levels could be set to default levels based on typical configurations and/or set based on the data collected in the commissioning process, which may take into account the distance of each infrared emission sensor 142 from the work space 120, which impacts both the size of the field of view pattern 144 on the floor and the level of the infrared emissions recorded by the infrared emission sensors 142. The levels can also be adjusted as a group for a particular environment. For instance, the default trigger sensitivity may be lowered in an office environment where the ceiling height is higher than typical. It will also be appreciated that the trigger levels can be adjusted on a sensor-by-sensor basis. If, in practice, the algorithms are not providing good results for a particular work area 110, the trigger levels may be re-programmed.

In some embodiments, each infrared sensor array 140 may communicate an infrared emission level or an estimated temperature for each of its infrared emission sensors 142 to the centralized controller 160. This information typically corresponds to two bytes (16 bits) of information, although a single byte could be used in some embodiments. Assuming two bytes of information per sensor 142, an infrared sensor array 140 that includes sixteen sensors 142 (e.g., a 4×4 grid) would transmit thirty two bytes (256 bits) of information to the centralized controller 160. Larger infrared sensor arrays 140 (e.g., an 8×8 grid of sensors 142) would transmit more information (e.g., 1024 bits of information). If data for each sensor 142 is transmitted once per second, then a communications capacity of 256 bits per second or 1024 bits per second would be required (at a minimum) between each infrared sensor array 140 and the centralized controller 160.

For hoteling systems, it may not be necessary to send data between the infrared sensor arrays 140 and the centralized controller 160 with a high frequency (e.g., every second), as determinations of occupancy may often be made based on whether or not movement is detected (and the amount of movement detected) over much larger periods of time. For example, workers will often leave their work space 120 during the work day to visit the break room or rest room, attend meetings, visit colleagues, etc. It may be desirable for the hoteling system 100 to recognize that such temporary absences from a work space 120 do not necessarily indicate that the work space 120 is unoccupied. Thus, the algorithms used by the centralized controller 160 may be set to indicate that a previously occupied work space 120 will assumed to still be occupied until some amount of time has passed (e.g., 15 or 20 minutes) without the detection of any movement (as reflected by changes in infrared emission levels or temperature) that is sufficient to suggest the presence of an individual. Because of this, in some embodiments, the infrared sensor arrays 140 may include circuitry so that they only transmit data to the centralized controller 160 when changes that are large enough to be significant are detected. This may reduce the amount of communications bandwidth required between each infrared sensor array 140 and the centralized controller 160.

Another method of reducing the amount of data transmitted between the infrared sensor arrays 140 and the centralized controller 160 is to communicate a level of change in detected infrared emission level or temperature. When this approach is used, various levels of change may be pre-defined such as sixteen different levels that can be represented by four bits instead of the 16 bits that may be used to denote actual emission readings. When such an approach is used, the levels may be set linearly or on another basis (e.g., exponential) so that the step size between adjacent levels may or may not be constant. It should also be noted that the infrared emission sensors 142 and/or the infrared sensor array 140 could make multiple readings in a row, then process these readings locally and only communicate selected changes, such as averages or maximum gradients. For example, each sensor 142 in the infrared sensor array 140 could take readings every 0.1 seconds but communicate only the largest change in sequential readings or the difference between the maximum and minimum over ten readings every second. Such approaches can substantially decrease the amount of information that needs to be transmitted, which may be is important in some embodiments to reduce computation complexity and optimize energy efficiency. In still other embodiments, the signal processing may be performed at each infrared sensor array 140 and occupancy determinations may simply be forwarded to the central controller 160.

The use of a commissioning process may be advantageous because it can be used to ensure that the boundaries of each work space 120 that are “programmed” into the hoteling system 100 accurately correspond to a desired area. In particular, the commissioning process will train the system 100 to know which infrared emission sensors 142 have a field of view pattern 144 that is entirely within a single work space 120 and which infrared emission sensors 142 have field of view patterns 144 that extend into multiple work spaces 120. The system 100 may also be pre-programmed with information regarding the division of field of view patterns 144 between multiple work spaces 120 (i.e., a field of view pattern 144 may primarily be within a first work space 120, but may have a small portion that extends into a second work space 120). This information may be used to effectively distinguish between movement in two adjacent work spaces 120 by evaluating the readings on the infrared emission sensors 142 that project into the two work spaces 120 over some period of time. Engineers that have experience with standard motion detectors will appreciate that determining the position of sensors to cover as much of a desired area as possible (to avoid false negatives) without exceeding the desired coverage area (which can result in false positives) is normally a challenging task, often requiring adjustments such as physical movement of sensors. The solutions provided according to embodiments of the present invention in which overhead-mounted arrays of sensors having narrow field of view patterns, coupled with potentially sophisticated “presence” algorithms, may be remarkably simple while also being both robust and flexible. More sophisticated algorithms will generally improve robustness. As an example, if a particular infrared emission sensor 142 has a field of view pattern that projects downwardly at a sharp angle directly onto a wall that separates first and second cubicles, presence may be detected if a user is on one side of the wall in the first cubicle and will also be detected when a user is on the other side of the wall in the second cubicle (i.e. user location cannot be assessed with confidence). In this situation, the algorithm can conclude with high confidence that there is presence (occupancy) in at least one of the first and second cubicles, but may mandate presence detection from other sensors 142 having field of view patterns that project into the first and second cubicles before locking in on a final decision as to the occupancy state of the first and second cubicles.

The hoteling systems according to embodiments of the present invention may be particularly advantageous as they may easily accommodate future changes in the layout of the work area. For example, at some time after the eighteen cubicles 120-1 through 120-18 are installed in the work area 110 of FIGS. 3-4, a decision may be made to add additional cubicles or other work spaces 120. For instance, an additional six cubicles 120-19 through 120-24 could be added in a new row along the bottom edge of FIG. 4 on the other side of walkway 124. Alternatively, the occupant of the facility may decide to reconfigure the cubicle layout to a different footprint a number of years down the road, replace the cubicles with desks or modular office space or the like. After these changes are made to the work spaces 120, the hoteling system 100 according to embodiments of the present invention can be re-trained based on the new work space boundaries by simply repeating the above-described commissioning process. The number of boundaries can be increased or decreased as desired without any need for installing new infrared sensor arrays 140 or moving existing infrared sensor arrays 140.

As is apparent from the discussion above, one potential advantage of using overhead-mounted infrared sensor arrays 140 to implement a hoteling system is that even if the work spaces 120 are rearranged in the future, it may not be necessary to relocate the infrared sensor arrays 140, as the infrared emission sensors 142 in the infrared sensor arrays 140 may be designed to densely “cover” the entire work area 110. This is possible because the infrared emission sensors 142 may be designed to project onto the floor at an angle, so that a relatively small number of infrared sensor arrays 140 may be mounted in the ceiling that have infrared emission sensors 142 with angled field of view patterns 144 that densely cover the entire floor of the work area 110. This can be seen, for example, with reference to FIG. 5, which shows how many, or even all, of the field of view patterns 144 for the sensors 142 included in an infrared sensor array 140 may project at an angle (e.g., the angles α and β shown in FIG. 5) from a vertical axis. In many cases, the angle from vertical of the central axis of the field of view cone 144 may exceed twenty degrees. In some embodiments, at least half of the infrared emission sensors 142 in each infrared sensor array 140 may project into the work spaces at an angle of at least twenty degrees from a vertical axis.

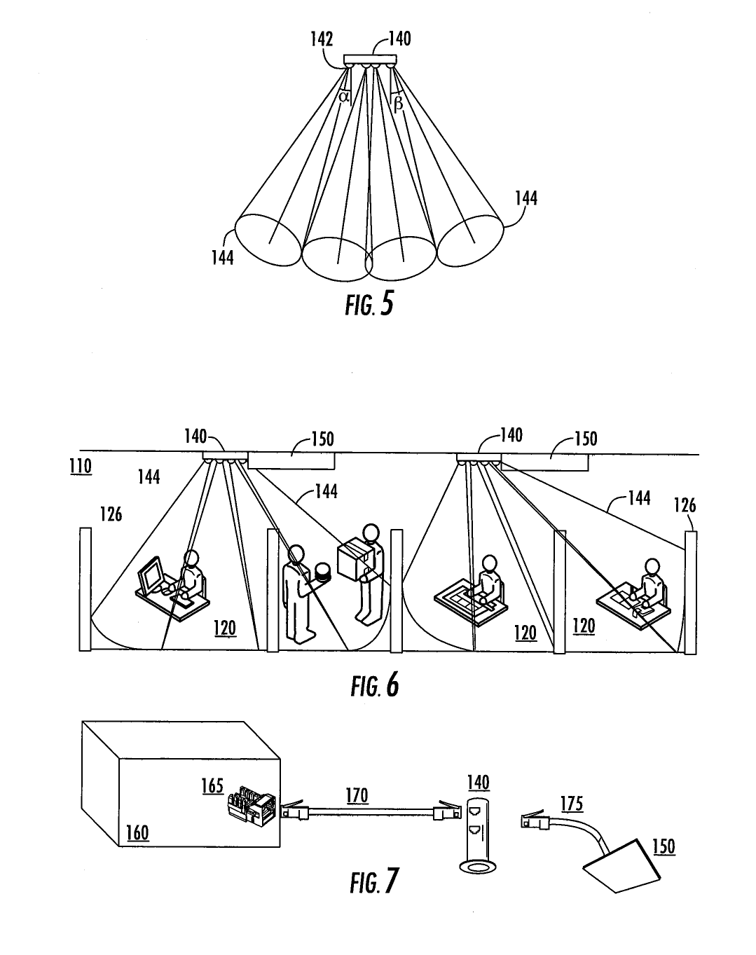

One consequence of having sensors 142 that have field of view patterns 144 that project onto the floor of a work area 110 at respective angles from a vertical axis is that objects may block the field of view patterns 144 of some of the infrared emission sensors 142. For example, as shown in FIG. 6, a work area 110 that has modular furniture work spaces 120 therein will have a plurality of walls 126 that are part of the modular furniture. The walls 126 extend only part of the way from the floor to the ceiling so that the work area 110 is an open work area. When a field of view pattern 144 of an infrared emission sensor 142 impinges on a wall 126, the wall 126 will typically “block” some or all of the field of view pattern 144 as the infrared emission sensor 142 will detect the infrared emissions from the wall 126 as opposed to from the floor on the far side of the wall 126. Thus, it will be appreciated that while infrared sensor arrays 140 may be installed that provide perfect coverage of the floor of an empty work area 110, once that work area 110 is populated with desks, chairs, filing cabinets, cubicles, modular furniture and the like, all or part of many of the field of view patterns 144 may be obstructed by objects in the work area 110, and this is particularly true with respect to infrared emission sensors 142 that have field of view patterns 144 that are at larger angles from a vertical axis (e.g., the field of view patterns 144 of the infrared emission sensors 142 on either end of the infrared sensor array 140 of FIG. 5).

In order to reduce this effect, pursuant to embodiments of the present invention, the field of view patterns 144 of the infrared emission sensors 142 of adjacent infrared sensor arrays 140 may be designed to overlap with each other so that obstructions such as cubicle walls that may block a first field of view pattern 144 of a sensor 142 on a first infrared sensor array 140 will be unlikely to block a second field of view pattern 144 of a sensor 142 on another infrared sensor array 140 that partially overlaps the first field of view pattern 144. This may improve the accuracy of the hoteling system 100. This arrangement may also help overcome misreadings that might otherwise occur as individuals move around the work area 110, as a person standing in a first work space 120 may block the field of view pattern 144 of an infrared emission sensor 142 that is aimed to project into an adjacent work space 120. During the commissioning process, the commissioning agent may be instructed to move throughout each work space (both walking around the work space and by moving around the work space while sitting in the chair) so that the impact that an individual may have when standing in a first work place on an occupancy determination with respect to a second work space may be taken into account in the occupancy determination algorithm. Likewise, the commissioning process may also have the commissioning agent stand and/or walk down the walkways 122, 124 as this likewise can falsely suggest presence in a work space, particularly for infrared emission sensors that project into work spaces at larger angles from a vertical axis. It will also be appreciated that in some embodiments and/or applications it may be desirable to define “presence” as meaning that an individual is sitting at the desk. In such embodiments, the commissioning/training process and the occupancy algorithms can be adjusted accordingly. Such techniques may provide excellent customization for specific user requirements without extensive custom programming, which can be expensive, to assure robust desired performance.

Another potential advantage of the hoteling systems according to embodiments of the present invention is that the infrared sensor arrays 140 can be co-located with the lighting system, if desired. Specifically, the infrared sensor arrays 140 can be mounted in, for example, the ceiling adjacent to light fixtures or can even be embedded within the light fixtures. Electrical power is already provided to the lighting systems in essentially all office environments, and this electrical power feed may also be used to power the infrared sensor arrays 140. Moreover, with the advent of solid state lighting solutions, there has been an increased interest in also communicating control information to and from light fixtures that may be used to control the lighting (e.g., on-off control, color control, dimming, etc.), particularly for purposes of energy savings (e.g., dimming or turning off lights in unoccupied work spaces). The infrared sensor arrays 140 that are used to collect data for occupancy determinations for hoteling purposes can also be used to set the light levels throughout the work area 110. Since a particular light fixture will typically provide lighting for multiple work spaces 120, the lighting control functions and the hoteling algorithms will typically be different. As one simple example, an individual may walk down the center of walkway 122 in the work area 110 of FIG. 3 without ever entering any of the work spaces 120. In this situation, the lights that illuminate the walkway 122 should turn on (or remain powered) even though the individual does not enter any of the work spaces 120 along the walkway 122. Using the infrared sensor arrays 140 to gather data that is used to both make occupancy determinations and to perform lighting control may be a very cost effective solution.

The infrared sensor arrays 140 typically require a direct current electrical power source. Running electrical power to infrared sensor arrays 140 may be very expensive, particularly when a work area 110 is retrofitted to include the infrared sensor arrays 140. In some solid state lighting systems, such as in Redwood Systems Building Management Solutions, direct current power is provided from a central location to power the solid state light fixtures. This direct current power source may also be used to power the infrared sensor arrays 140 used in embodiments of the present invention, and the infrared sensor arrays 140 may be used to collect data that is used both to gauge the occupancy of the work spaces (for hoteling purposes) and to control the solid state light fixtures (for energy savings and other lighting control purposes). Moreover, the same wires that are used to provide electrical power to the lights and infrared sensor arrays 140 may also be used to carry communications between the centralized controller 160 and the infrared sensor arrays 140. For example, the Redwood Systems Building Management Solution is already designed to transmit general information from sensors back to a central location as well as receive information from the central location. Transmitting incremental information is thus a simple low-cost and effective extension. As the use of solid state lighting (and particularly automatically controlled solid state lighting) may be cost-effective based on energy savings alone, the incremental cost of implementing a hoteling system may be very small since the same sensors, electrical power cabling and communications cabling may be used for the hoteling system that is already in place for the lighting system.

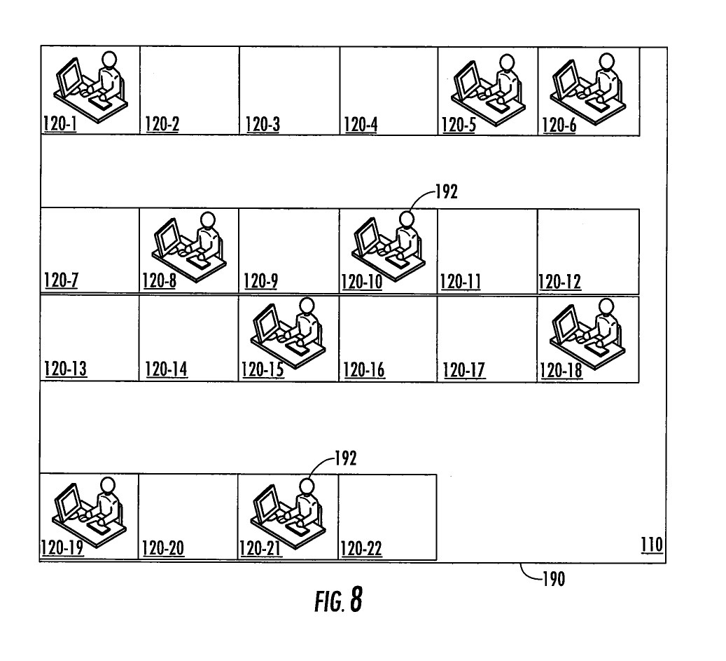

FIG. 7 is a schematic diagram illustrating how the infrared sensor arrays 140 used in embodiments of the present invention may be integrated with a solid state lighting system.

As shown in FIG. 7, a plurality of infrared sensor arrays 140 may be mounted in a ceiling, generally adjacent to (or as part of) a light fixture 150 (infrared sensor arrays 140 that are generally adjacent to or as part of a light fixture 150 may be referred to herein as being “co-located” with the light fixture 150). A cable 170 may electrically connect the infrared sensor array 140 to a controller 160. In the depicted embodiment, the cable 170 comprises an Ethernet patch cord having one or more twisted pairs of conductors, and the controller 160 includes an RJ-45 jack 165 that the cable 170 plugs into. However, it will be appreciated that other types of cables may be used. It will also be appreciated that more than one cable 170 may be interposed between the infrared sensor array 140 and the controller 160, and that one or more connectors may be used to electrically connect such cables together.

The light fixture 150 may comprise, for example, a ceiling-mounted solid state light fixture such as a light emitting diode (“LED”) based light fixture that includes a plurality of LEDs. The light fixture 150 may be powered, for example, by a direct current electrical signal that is transmitted to the light fixture 150 through the controller 160, the patch cord 170, the infrared sensor array 140, and another patch cord 175 that connects the light fixture 150 to the infrared sensor array 140. The infrared sensor array 140 may also be powered by this same direct current electrical signal. Thus, as both the infrared sensor array 140 and the light fixture 150 may be powered over a common cable, the cost of implementing the hoteling systems according to embodiments of the present invention may be reduced. It will also be appreciated that in other embodiments a parallel connection may be used or that a serial connection may extend from the controller 160, to the light fixture 150 and then to the infrared sensor array 140.

Additionally, the infrared sensor array 140 may also be used to control the lighting. For example, as discussed in U.S. Pat. No. 8,159,156, the entire content of which is incorporated herein by reference as if set forth in its entirety, motion detectors or other sensors may be used to control light fixtures for various purposes such as energy conservation. Ceiling mounted motion detectors may be used, for example, to detect movement, and light fixtures that are within predetermined distances from the detected movement (or which are associated with the sensor) may be turned on, while other light fixtures which have associated sensors that do not detect any movement may be dimmed or turned off to conserve electricity. Pursuant to embodiments of the present invention, the infrared sensor arrays 140 may be used both to sense presence within work spaces 120 for purposes of implementing a hoteling system 100, and at the same time may also be used as motion detectors to detect movement that is used to control, for example, an illumination level of one or more light fixtures 150.

Moreover, data for controlling the light fixtures 150 and data transmissions between the infrared sensor arrays 140 and the controller 160 that is used in implementing the hoteling system 100 may be transmitted over the same cabling (e.g., cables 170 and/or 175) that is used to transmit the power signals to the infrared sensor array 140 and the light fixture 150. For example, U.S. Pat. Nos. 8,427,300 and 8,058,750, the entire contents of which are incorporated herein by reference as if set forth fully herein, disclose various methods of embedding uplink and downlink control/data signals onto a pair of wires that are used to electrically power sensors and light fixtures. In some embodiments of the present invention, the techniques disclosed in these patents may be used to transmit data from the infrared sensor arrays 140 to the controller 160. In some embodiments, the same cabling may be used to provide electrical power to both the infrared sensor array 140 and the light fixture 160 and to transmit data and control signals between the controller 160, the infrared sensor array 140 and/or the light fixture 150. In such embodiments, little or no additional cabling may be needed to implement a hoteling system as the hoteling system may use cabling that is installed for other purposes. This can greatly reduce the marginal costs associated with implementing the hoteling system.

The use of RJ-45 patch cords, cables and/or connectors may be well-suited for systems in which the infrared sensor arrays 140 and LED-based light fixtures 150 are powered over a common cabling connection. RJ-45 patch cords typically include four twisted pair of insulated conductors and hence have multiple pairs of conductors that may be used to power and/or control multiple electronic devices such as LED-based light fixtures 150 and/or infrared sensor arrays 14Q. Additionally, the conductors in RJ-45 patch cords may be relatively high gauge wires that are suitable for powering low voltage devices while providing thinner, lighter cabling that may be less expensive and easier to install than traditional electrical wiring for light fixtures. Moreover, RJ-45 plugs on the patch cords may be readily inserted and removed from RJ-45 connectors that are included in the light fixtures 150 and/or in the infrared sensor arrays 14Q which may further simplify installation. RJ-45 connectors and patch cords may be designed to have low levels of crosstalk between the four pairs of conductors and hence may also be well-suited as a communications medium for control signals that are used to control the LED-based light fixtures 150 and/or the infrared sensor arrays 140 and for data signals that may be transmitted from the infrared sensor arrays 140 to a central controller 160 that is at a remote location. In some embodiments, a single pair of conductors in an RJ-45 cabling connection (i.e., a series of RJ-45 patch cords, cables and connectors that connect a first device to a second device) may be used to power an infrared sensor array 140, control the infrared sensor array 140 and transmit data from the infrared sensor array to a central controller 160. Others of the pairs of conductors in the RJ-45 cabling connection may be used to power, control and communicate with other infrared sensor arrays 140 and/or light fixtures 15Q.

Pursuant to further embodiments of the present invention, the occupancy data collected gathered by the hoteling system may also be supplied to building control systems (other than lighting control systems). For example, in some embodiments, the occupancy data may be used to control building heating and/or cooling (“HVAC”) systems. HVAC systems in commercial office building typically have a plurality of heating and/or cooling zones such as groups of offices and other rooms and common areas that may be individually controlled for heating and cooling purposes. The occupancy data generated by the hoteling system may be used to identify heating/cooling zones in which all of the rooms are unoccupied, and the HVAC system may be adjusted in such zones to provide less heat or air conditioning for purposes of energy savings. An algorithm may be used to control the HVAC system that considers, for example, how long a heating/cooling zone has been unoccupied, the occupancy state of offices/rooms in adjacent heating/cooling zones, the time of day and the like to make decisions on when to adjust settings of the HVAC system based on the occupancy data and how large those adjustments may be.

As another example, offices and other rooms with external windows in commercial office buildings may have mechanical curtains or automated window shades that may be automatically controlled. The occupancy data from the hoteling system may be provided to a controller for such mechanical curtains or automated window shades to shut the curtains/shades when appropriate for reducing heating and cooling costs (e.g., shutting the blinds during daylight hours when offices are unoccupied in the summer and during nighttime hours when office are unoccupied in the winter). In still other embodiments, the occupancy data may be used in conjunction with information collected by an intelligent patching system to power down devices that are powered through network cabling via, for example, power-over-Ethernet. U.S. patent application Ser. No. 13/353,808 (“the '808 application”), filed Jan. 19, 2012, the entire contents of which are incorporated herein by reference, discloses automated infrastructure management systems that may be used, for example, to reduce energy costs by powering down power-over-Ethernet powered devices on pre-defined schedules and/or based on “presence” data obtained using card readers and smartphones. It will be appreciated that the occupancy data collected through the hoteling systems according to embodiments of the present invention may be incorporated into any of the automated infrastructure management systems of the '808 application to provide additional, improved automated infrastructure management systems which power down equipment additionally and/or alternatively based on occupancy data. As a specific example, occupancy data may be used to power down computers or printers in certain, pre-selected offices that are determined to have been unoccupied for at least a pre-determined amount of time. Thus, the occupancy data collected by the hoteling systems according to embodiments may be leveraged to obtain further costs savings. Additionally, the occupancy data may also be used for other purposes such as part of an employee time clocking system as it will generate data regarding when employees were present in their work spaces (in situations where employees have permanently assigned work spaces or are temporarily assigned to specific work spaces).

While it may be desirable in various applications to use the infrared sensor arrays 140 to perform sensing for both making occupancy determinations for hoteling purposes and also for sensing presence for purposes of controlling the lighting system, it will be appreciated that, in other embodiments, separate sensors such as standard motion detectors may be used for lighting control purposes. In these embodiments, the cabling to the light fixtures may, if desired, still be used to power both the light fixtures and the infrared sensor arrays 140 (and the motion detectors), and/or for the communications between the central controller and the fixtures and sensors.

While in some embodiments the data may be transmitted between the infrared sensor arrays 140 and the centralized controller 160 over cabling connections, it will be appreciated that in other embodiments wireless communications may be used. The exact wireless frequency band suitable for use may vary by country, and access from multiple devices may need to be negotiated. Wireless technology continues to evolve quickly so there is also risk that current wireless technology will not be compatible with new technology introduced in the future. For all these reasons, wired communications connections may be a preferred alternative in some embodiments, but wireless is nonetheless an option.

FIG. 8 is a schematic diagram illustrating a graphical display 190 of the hoteling system that may be used to show work space occupancy state information. As shown in FIG. 8, the hoteling system 100 may generate a graphical display 190 that depicts a work area 110 that is monitored by the hoteling system 100. The work spaces 120-1 through 120-22 that are included in work area 110 are depicted in the graphical display 190 in an overhead view that represents the floor plan of the work area 110. Graphical indicators 192 of occupancy such as, for example, a graphic of a person at a desk, a color (e.g., filling in occupied work spaces 120 with a red fill), etc. may be used to indicate the work spaces 120 that are presently occupied. Different graphical indicators (or the absence thereof) may be used to indicate unoccupied work spaces that are available for use.

Using overhead mounted infrared sensor arrays that have sensors with narrow field of view patterns may have a number of advantages over other potential hoteling approaches. For example, the use of arrays of sensors allows for a high density of field of view patterns in a work area, so that multiple field of view patterns will typically be present within the footprint of each work space. This means that even if the work space layout is rearranged later, it is highly likely that there will still be multiple sensors having field of view patterns that fall within each work space, and that the field of view pattern for at least one respective sensor may be substantially entirely within a given work space. Such an arrangement can also provide more accurate occupancy information by reducing the likelihood of false positive and/or false negative readings.

As another example, the infrared sensor arrays may be overhead-mounted according to embodiments of the present invention. This may, in some embodiments, avoid any need to rewire electrical power cables and/or communications cables to the infrared sensor arrays as would often be the case, for example, if the sensors are mounted in cubicle or modular furniture walls or on or within furniture such as desks, chairs and the like. Moreover, in order to avoid such cable rewiring, prior art solutions use battery operated, wireless sensors. However, as these devices are typically powered-on continuously, or at least take frequent readings such as a reading every few seconds, they may quickly drain the batteries, and hence require constant maintenance in the form of battery checking and replacement.

Embodiments of the present invention have been described above with reference to the accompanying drawings, in which embodiments of the invention are shown. It will be appreciated, however, that this invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements and/or components, but do not preclude the presence or addition of one or more other features, operations, elements, components and/or groups thereof.

Note that in the claims appended hereto, various references are made to “each” of a plurality of objects (e.g., sensors, sensor arrays, etc.). It will be understood that claim limitations that reference that each object has certain characteristics does not preclude the inclusion of additional objects that do not have the recited characteristic. By way of example, a claim to a hoteling system that includes a plurality of infrared sensor arrays, where “each” of the sensor arrays includes a plurality of sensors, will cover a hoteling system that has at least two infrared sensor arrays that each have at least two sensors, regardless of whether or not the hoteling system also includes an infrared sensor array that only has a single sensor. Thus, the use of the word “each” in the claims that follow must be read in the context of the open-ended claims that follow that do not preclude the addition of further subject matter (e.g., an infrared sensor array with only one sensor in the example above) that is not positively recited in the claim.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

1. A hoteling system for an open work area that includes a plurality of work spaces, comprising:
a plurality of infrared sensor arrays mounted above the open work area, wherein each infrared sensor array includes a two-dimensional array of infrared emission sensors, wherein the field of view patterns of at least some of the infrared emission sensors project into the work spaces; and
a controller that is remote from at least some of the infrared sensor arrays and that is in communications with the infrared sensor arrays, the controller configured to determine an occupancy state of each of the work spaces based at least in part on information received from the infrared sensor arrays.

2. The hoteling system of claim 1, wherein a first of the occupancy state determinations is based on information received from at least two of the infrared emission sensors.

3. The hoteling system of claim 1, wherein a first of the occupancy state determinations is based on information received from two infrared emission sensors that are from different infrared sensor arrays.

4. The hoteling system of claim 1, wherein the occupancy state determination for a first work space is based on comparing information received from infrared emission sensors that have field of view patterns that project into the first work space to stored criteria that are based on data that was recorded during a commissioning process for the work area.

5. The hoteling system of claim 1, wherein the field of view patterns of at least two of the infrared emission sensors from one of the infrared sensor arrays project into the same work space.

6. The hoteling system of claim 1, wherein the field of view patterns of a first infrared emission sensor of a first of the infrared sensor arrays and of a second infrared emission sensor of a second of the infrared sensor arrays project into the same work space.

7. The hoteling system of claim 1, wherein a first infrared sensor array is powered via a cable that includes at least first and second conductors, and wherein the information received from the first infrared sensor array is transmitted to the controller over at least one of the first and second conductors.

8. The hoteling system of claim 7, wherein the first and second conductors of the cable provide a power signal to a light fixture.

9. The hoteling system of claim 8, wherein at least one of the first and second conductors are configured to provide a transmission medium for transmitting control signals that are used to control the light fixture.

10. The hoteling system of claim 1, wherein an occupancy state determination for a first work space is based at least in part on the detection by a first of the infrared sensor arrays of a change in temperature that exceeds a predetermined magnitude and that occurs within a predetermined time.

11. The hoteling system of claim 1, wherein at least two of the plurality of infrared sensor arrays are powered by a common cable.

12. The hoteling system of claim 1, wherein at least one of the infrared emission sensors in a first infrared sensor array has a field of view pattern that partially overlaps with the field of view pattern of at least one other of the infrared emission sensors in the first infrared sensor array.

13. The hoteling system of claim 1, wherein at least one of the infrared emission sensors in the first infrared sensor array has a field of view pattern that partially overlaps with the field of view pattern of an infrared emission sensor in a second infrared sensor array.

14. The hoteling system of claim 1, wherein the infrared sensor arrays are mounted in or from a ceiling of the work area, and wherein at least half of the infrared emission sensors in each infrared sensor array project into the work spaces at an angle of at least twenty degrees from axes that pass through the infrared emission sensors that are normal to a plane defined by the ceiling.

15. A method of assigning work spaces in a hoteling system, the method comprising:
detecting infrared emissions within individual work spaces in an open work area using a plurality of overhead mounted infrared sensor arrays, wherein the infrared sensor arrays each include a plurality of sensors and the infrared sensor arrays are arranged so that field of view patterns of multiple of the sensors extend into each work space in the open work area;
transmitting data from the infrared sensor arrays to a controller;
using the controller to determine an occupancy state of each of the work spaces based at least in part on the data received from the infrared sensor arrays; and
assigning a work space that has been determined to be currently unoccupied to an individual.

16. The method of claim 15, further comprising generating and automatically updating a graphical display that illustrates the determined occupancy state of the work spaces.

17. The method of claim 15, further comprising:
measuring the infrared emissions detected by each sensor in the infrared sensor arrays that is associated with an individual moving in each of the work spaces;
using the measured infrared emissions in making the occupancy state determinations.

18. The method of claim 15, wherein the infrared sensor arrays comprise Grid Pattern Infrared sensor arrays that detect infrared emissions and convert the detected infrared emissions to temperature values.

19. The method of claim 15, wherein a first of the infrared sensor arrays is powered via a cable that includes at least first and second conductors, and wherein the data is transmitted from the first infrared sensor array to the controller over at least one of the first and second conductors.

20. The method of claim 19, wherein the first and second conductors of the cable provide a power signal to a light fixture, and wherein at least one of the first and second conductors is configured to provide a transmission medium for transmitting control signals that are used to control the light fixture.

21. The method of claim 15, wherein each occupancy state determination is based on information received from at least two of the infrared emission sensors.

22. The method of claim 15, wherein the occupancy state determination is based at least in part on the detection of a change in temperature that exceeds a predetermined magnitude and that occurs within a predetermined time.

23. The method of claim 1, wherein the field of view patterns of infrared emission sensors from at least two infrared sensor arrays project into at least some of the work spaces.

24-25. (canceled)
